(19) United States
(12) Patent Application Publication
(10) Pub. No.: US 2005/0144033 A1
(43) Pub. Date: Jun. 30, 2005

(54) Structured products based enterprise management system

(75) Inventors: Mark Simon Vreeke, Houston, TX (US); Viren Harshad Kapadia, Houston, TX (US)

Correspondence Address: Mark Simon Vreeke, 14603 Cedar Point, Houston, TX, 77070, US

(73) Assignee: Rational Systems, LLC

(21) Appl. No.: 11/025,162

(22) Filed: Dec. 29, 2004

Related U.S. Application Data
(60) Provisional application No. 60/533,417, filed on Dec. 30, 2003.

(51) Int. Cl. G06F 17/60

(52) U.S. Cl. 705/1

(57) ABSTRACT

The field of invention is in Information Technology based management systems for the natural gas, data communications, electricity, medical, government supply chain and vehicle markets. The disclosed system manages core commercial activities and business for companies in these industries. These systems are specifically designed to not only handle complex transactions but to also allow the same system to be used across all core business functions, including: marketing, sales, contracting, production, delivery, business optimization and financial settlement.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

The field of invention is in information technology based systems that manage core business activities specifically those business activities that are complex in nature.

### BACKGROUND OF THE INVENTION

Most e-commerce transactions are simple in nature. For example, the retailer to consumer business process is a direct sequence of events; browse a catalog, make a selection, make a payment using a credit card and deliver the purchased product. The entire transaction is completed with a single interaction between the seller and the buyer. This type of transaction does not reflect the complex nested transactions of many of today's commercial transactions. Transactions in the business world are often long lived propositions, involving: negotiations, commitments, contracts, floating exchange rates or other complex financial derivatives, shipping and logistics, tracking, varied payment instruments, exception handling and termination or satisfaction. Each of these stages may cycle multiple times with prior transactions impacting present transactions and present transactions creating additional commitments for future transactions.

In a joint white paper of the Object Management Group and CommerceNet, Gabriel Gross, President of Centre Internet European, summarized the current state of electronic commerce applications as

Mainly limited to two functionalities: cataloging on one side and payment facilities on the other side. The current electronic commerce world is in practice a lot less sophisticated than real world commerce where several levels of interaction can take place between potential client and vendor, and several levels of intermediaries can act or interfere.

At a basic level, commercial transactions have two phases:
1) Construction
   a) Information collection involving catalogues and brokerage systems to locate sources;
   b) Agreement leading to terms and conditions through negotiation mechanisms; and,
   c) Engagement resulting in the “signed contract”.
2) Execution
   a) Configuration involving deployment across the group of participants in the transaction;
   b) Service execution in context of the higher level contract and management of exceptions; and,
   c) Termination involving validation and closing the contract across all participants. Termination may be long lived as contracts may include ongoing service agreements with the customer and other aspects of overall customer relationship management.

Ideally an information technology system will integrate other aspects of a business into the transaction process. This integration will allow for optimization of business processes. The integration of physical capabilities will allow for maximum resource utilization. Integration of financial data will allow for maximization of revenue. The greatest potential gain comes from the combined integration of contracting, physical capabilities and financials to allow optimization according to marginal costs. Through a marginal costing approach a business can maximize net income.

Enterprise systems must also address the world of multi-seller, multi-buyer commerce. This requires building information systems capable of handling/processing simultaneous requests from multiple users. Inherent to this disclosed system is a request scheduling process, which prioritizes, queues and processes the requests of multiple users.

In addition, a complex transaction or business process requires management of many dynamic roles: customer (the one who pays), consumer (the one who receives), merchant (the one who gets paid) and provider (the one who delivers). Additional sub-roles also exist, including: brokers, aggregators, referral services and other forms of intermediation. Additional supporting roles exist, including: bankers, credit providers, shippers, insurers and other third parties. Each of these roles imposes requirements on the Enterprise System.

The underlying data sources must be accessible to meet the different information needs of each role and procedure. This disclosed system maintains data at the minimal level of granularity required by any system, subsystem or role. This level of granularity ensures that no data are lost by a roll-up process. While stored at a granular level the data must possess the structural information needed to reassemble the data into any required format. Again this disclosed system allows for the summation and efficient handling of the granular data.

Enterprise systems require the inter-operation of computer applications, which depend upon consistent protocols and formats for information exchange. The complexity of building such virtual marketplaces mandates a computing paradigm based on standards. Otherwise inter-operability is impossible. The ultimate purpose of these standards is to develop consistent business semantics used by all participants—a common language of digital commerce. The extent of today's solution is to provide commonality to the names and relationships of processes, workflows, and data across all value and supply chains. This commonality is often provided through direct mapping of fields and/or translation tables.

An example is the new standard for defining and naming data on a Web page adopted by the World Wide Web Consortium (W3C) in 1997. The Extensible Markup Language (XML) allows structured data—with standard names and consistent semantics—to be moved around the Web in a simple, straightforward manner. XML is, however, little more than the reintroduction of the “unit record concept” introduced with the punch card in the 1950s. These cards stored chunks of data (fields) that were tagged with names giving them attribute/value pairs bound together as a standalone document (record). In other words, XML is simple text data (ASCII) and must be linked to an underlying infrastructure in order to handle the adaptive business processes and workflows needed for e-commerce. The most difficult aspect of inter-operability is to gain global agreement and definition of the underlying processes and procedures—an effort that has eluded information systems designers since the introduction of centralized databases. Thus, XML enables the use of the consistent business semantics but does not provide for the complex processes or functions. The disclosed system goes beyond simply creating a uniform naming structure. This system provides a structure for defining the entire process that lies on top of the data structure.

Without consistent business semantics, the business processes and workflows cannot be shared between multiple organizations or even inter-company departments. However, even with consistent semantics the task knowledge needed for such activity, adaptive business processes and workflows, overwhelms current software paradigms. A proposed solution is the use of intelligent agent technology, which is based on task level knowledge and knowledge sharing standards [such as a simplified version of the Knowledge Interchange Format (KIF)]. Today's intelligent agent technology is still in its infancy and, therefore, cannot approach the knowledge base required to prepare transactions. This disclosed system provides for a basic transaction language to describe the complex transactions and processes. The language focuses on supporting human decision makers not replacing them.

Enterprise computing seeks to consolidate and harmonize the many disparate information systems and data sources scattered throughout an enterprise into a unified whole. The goal is to streamline business processes and enable outward-facing information systems. The attention given to enterprise computing in recent years is a result of the business process re-engineering revolution, which was enabled by information technologies such as client/server computing. Through some hard learned lessons, corporations now know that it is insufficient to wire together machines through a network using a client/server architecture. A coherent information model and technology architecture was missing from this structure.

The disclosed system provides the much needed solution. Rights and engines define the core of this system. The Rights maintain subsystems and roles, at the most granular level required by any business system. The engines are responsible for the exercise of these Rights. Maintaining sufficient granularity ensures the integrity and availability of all system data. In other words, the core of this system prevents the loss of data by storing all data centrally in one usable format. These core Rights are subsequently developed into hierarchical structures. The hierarchical structures may involve tiering relationships within and between the Rights. These tiered hierarchical structures allow the creation of complex transactions and processes.

Object oriented computing is touted as the solution for managing the ever-growing complexity inherent in computing solutions. Objects are chunks of software that reflect real things in the real world: customers, employees, orders, shipments, and so on. Objects combine their processes and their data into a single entity in such a way that the integrity of the object is ensured by the object itself. This is in contrast to the relational database model typical of client/server architectures, where data is isolated from the processes that manipulate it. Such processes may be scattered across an organization resulting in integrity and complexity problems when they are integrated. Companies that tried to link the relational databases with the processes that use them created incomprehensible spaghetti architectures. These spaghetti architectures failed to create a unified enterprise information infrastructure. The structured products approach maintains the data in its most granular form. Therefore, data is exposed to all systems and the web of interconnected data sources is avoided. Each organization or business area is subsequently responsible for the reconstruction of the data to produce their required view of the business.

The next evolution in object oriented design, distributed object computing, is recognized as the future for building enterprise information architectures. Objects communicate to one another, to users and other systems by presenting interfaces with their services. To ask an object to perform a task, the object is sent a message requesting a service. In essence, using objects to build information systems is like building a simulation that includes the representation of people, places, things and events, which are found in the business setting or domain. Four key advantages result:
1) Objects reflect the real world and, thus, greatly enhance understanding and communication among systems developers and business people;
2) Objects are stable, allowing the object's internals and interfaces to be changed without affecting other parts;
3) Objects help achieve software reuse as they are extended through mechanisms, such as inheritance, without rewriting the entire object; and,
4) Objects reduce complexity as programmers do not have to understand the internals of the object. They do not need to know how an object works internally, only what the object is and to what messages it responds (i.e. how to communicate to the object).

Distributed object computing has evolved rapidly over the past five years. Early uses of this computing paradigm dealt with system or “technology” objects. A printer is a simple technology object. A programmer no longer needs to “program” a printer. Instead the programmer sends the printer object a message to request the object take care of printing the current document. Traditional procedural programming required that programmers know all about programming printers, carefully writing each instruction to handle line feeds, tabbing and so on.

While technology objects simplify coding, they do not address the business applications or business semantics. The object-oriented solution created of a higher level of abstraction allowing information system developers to work with objects representing business entities and processes. At this level of abstraction, powerful business information models were designed with object-oriented concepts. These business objects handled the tasks of business processes and activities while suppressing the details of the underlying objects. The details were needed, of course, but the internals of the business object managed theses matters by sending appropriate messages to the underlying objects. While at an abstract level the use of objects to manage business processes is both appealing and practical, implementation problems exist. In an enterprise system the underlying data and the corresponding processes are frequently used across the entire system. This requires the exposure of the process and underlying data which is exactly what true object oriented design attempts to prevent. The disclosed system presents a unique combination of business objects with exercise engines and data structures. While the exercise engines control the processes, the granular data structure ensures data availability across business units. The business objects are built upon these shared structures.

The “Holy Grail” of enterprise systems is to allow the business user to define, manage and maintain the business functions. Thus, control of the implemented business processes is returned from the realm of the corporate information technology department to the domain of the business user. In this regard, Common Object Request Broker Architecture (CORBA) made system and technology inter-operations available, and many mission critical business systems and applications have been developed. The interface definition language (IDL) specification allows programmers to write and publish interfaces that are used by objects anywhere. To date, however, developers must still master a mix of business object semantics and the underlying technology objects, which require low-level plumbing, in order to build complete business solutions. A business object component model that suppresses the complexity of the underlying systems technology is needed to provide a clear separation of concerns. With such a system, business solution developers can assemble and tailor pre-built business components into complete solutions.

Technologists are component assemblers and deal with the complexity of the underlying information systems and technology infrastructure. Computer specialists are the tool-smiths for building reusable components. Because business objects provide the abstractions needed for building high-level components that inter-operate, business solution developers are able to assemble applications using business constructs and semantics that insulate them from the underlying complexity. The ultimate language of application development will be the “language of business,” not “the language of computers”, and eventually business users will develop their own information systems solutions to business problems. Only when the business user can accomplish the tasks originally in the domain of the computer specialist, can the goal of a truly agile business be realized. The disclosed system creates the structures necessary to minimize the services of a computer specialist. Business strategies identified by the business users can be implemented on an enterprise wide scale using this disclosed system.

The component paradigm has changed “programming.” Application programmers who made up the bulk of commercial information technology shops are being replaced by technologists assembling components. The components are not delivered to corporations as a big pile of parts and pieces. Instead the components arrive pre-assembled into industry specific application frameworks. These frameworks represent applications that are nearly complete. The task of solutions developers will be to customize the components of the frameworks to meet the unique needs of the specific company.

Solution developers will concentrate on the unique character and knowledge of the company, which accounts for the company's competitive advantage. The extension and tailoring of components will focus on the user interfaces and will involve both graphical and task-centered customization. In the long run, corporations will no longer need to waste resources designing their own applications. Instead, they will buy component-based enterprise application packages. These packages, however, will not be the complex, confusing packages available in the current market. Instead, the framework of these packages will be based on distributed object architectures, allowing for individual components to be mixed and matched regardless of the individual software vendor. The disclosed system is such a framework. But rather than an ancillary function of merging different systems, the disclosed framework represents the core of the business to which the other components are attached. Only with a granular data structure and the necessary exercise engines can the component approach be implemented in a flexible fashion. The disclosed system is specifically tailored to the forecast, sales, contracting, supply chain and settlement process that are at the foundation of any business.

SAP and other enterprise resource planning (ERP) vendors are aggressively implanting their software based on case studies into business (not computer science) curriculums at both the graduate and undergraduate levels. This will result in business graduates who can build information systems from frameworks. The programmer as “translator” between the business and the digital domain will fade into history. However, the true benefits of component assembly will not be realized without the disclosed structured products approach providing the framework to which the components may be attached.

### SUMMARY OF THE INVENTION

In one aspect, the disclosed system serves as a development language for business users. CommerceNet is working on a Common Business Language (CBL) to blend e-commerce components into their evolving eCo System architecture. Other high level tools, such as VisualAge for Java, serve as component assemblers that suppress the details and complexity of the underlying technologies and systems. Basic, Pascal and similar high-level languages were created to hide the complexity of machine code. The novelty in the structured products system is that the language of the business user is used to create the business functions. The disclosed system lies between the abstract level of CommerceNet and higher-level languages. This business user accessibility allows for the creation of truly agile business solutions.

The basis of the disclosed system is the process of disassembling a service into its individual atomic Rights. These Rights are then defined and assembled within the system to create mass customized services. At the most basic level, the Rights specify a unique collection of parameters. Thus, the user is not tied to any database type structure and the Rights are amorphous.

An additional feature of the disclosed invention is the exposure of the Right parameters to the business user. The parameters are accessible and, therefore, allow Rights to be configured as a typical business user builds them into services.

Another novel feature of the disclosed system allows for the Rights to be associated into complex structures, such that they depend upon other Rights or services. This allows for both Rights and services to be inter-related. This results in one Right or service having the ability to affect others, depending upon the actual utilization of the Right or service adopted by the customer.

Furthermore, each Right can be associated with other objects or parameter groups, including: scheduling priority, pricing, marginal cost, and actual cost. These additional structures enable the seller to configure management systems for the services he provides.

Another novel feature of the disclosed system is that the pricing object associated with a Right is modeled as an option. Option pricing format allows a base charge for actually having the Right/Service and an incremental charge for the utilization of the Right/Service.

Another novel feature is the system's capacity to manage products in the service industry. The use of the term Service to represent an assembly of Rights was intentionally used to accent the applicability of the system to all industries, including; those that sell tangibles and intangibles.

Additionally, the disclosed system allows for the entire scheduling system to be changed by simply modifying the scheduling priorities of each Right. This can be done without writing any additional code, a revolutionary feature of this system. During Right definition and service creation each Right is assigned a scheduling value. After a Right has been utilized in a given circumstance (exercised), a scheduling value is automatically read from each Right. For the Rights exercised, scheduling values are subsequently summed to determine the scheduling priority of the individual service. The scheduling of the actual services is achieved by sorting the totaled scheduling priorities. Thus, scheduling is simply a number map schema of all of the scheduling priorities and their summation under different conditions.

Other aspects and advantages of the present invention will become apparent from the following detailed description taken in conjunction with the accompanying drawings illustrating by way of example the principles of the present invention.

### BRIEF DESCRIPTION OF THE DRAWINGS

FIG. 1 is a flow diagram that shows the basic elements of a Right.

FIG. 2 is a flow diagram that shows a more advanced version of the Right definition process.

FIG. 3 is a flow diagram that shows a Right with Objects (Parameter Groups) attached to individual parameters.

FIG. 4 is a flow diagram that shows a Right with an Object or Parameter group attached directly to the Right.

FIG. 5 is a flow diagram that shows the detailed view of the pricing object.

FIG. 6 is a flow diagram that shows the most elemental method of Right assembly yielding a complex Business function.

FIG. 7 is a flow diagram that depicts the elements of a fully featured Right assembly system.

FIG. 8 depicts the role of input parameter mapping for the population of the Rights defined in a service template.

FIG. 9 shows a generic business process and the engines, which support the process.

FIG. 10 is a flow diagram that shows some of the business functions supported by the structured products core.

FIG. 11 shows the structured products core supporting multiple business areas and functions.

FIG. 12 is a flow diagram that shows the concept of a service within the framework of the Rights, Right hierarchy, input mapping and the Rights operation/Exercise engines

FIG. 13 is a graph that presents one concept of the “Cube”, which is an analysis tool for the visualization of the multi-dimensional data.

### DETAILED DESCRIPTION OF THE INVENTION

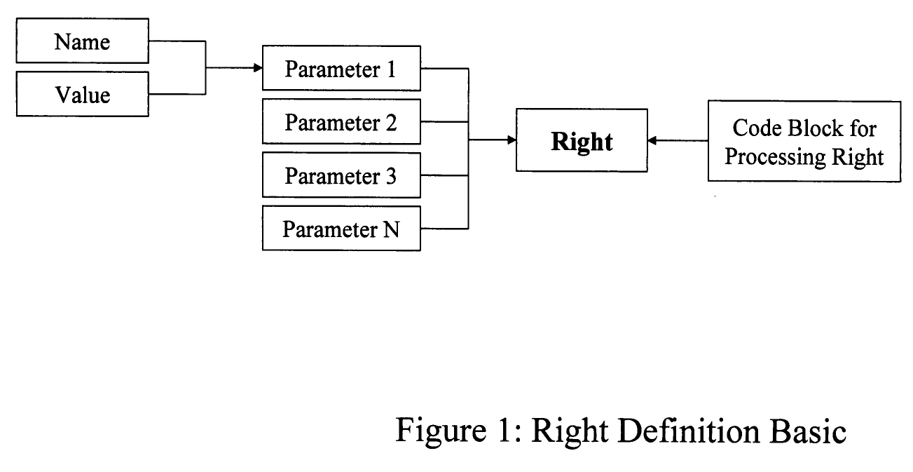

FIG. 1 is a flow diagram showing the basic elements of a Right. A Right represents an elemental function defined by the business. The Right has sufficient granularity to preclude the summation of business detail. Maintaining the Rights at this level of granularity allows for the Rights to form the basis of every system within the enterprise. If data were not stored at the finest granularity required by any system within the enterprise, business details would be lost during the processing. The loss of data would prevent the system from being able to “see” every aspect of the business. The only alternative to maintaining the data at the finest level of granularity would be to store the data in redundant databases in which, each is specialized for its specific business process. This approach would defeat the benefit of using the Rights based processing as the basis for the enterprise system.

There are many different types of Rights, including: scheduling, pricing, transportation, transformation and storage. Each of these Rights represents an elemental business function. As shown in FIG. 1, a Right is composed of parameters and an element of code. Multiple parameters may be attached to each Right. Each parameter defines a certain aspect of the Right. For example, a Transportation Right, which deals with the shipping of a product, will need parameters defining: the item(s) being transported, the quantity transported, the location and destination of the item(s), the mode of transportation, and the transportation route. A Transformation Right can be used as another example. A Transformation Right, which defines the conversion of starting material(s) into product(s), will require parameters detailing the raw and finished products, conversion rates, and conversion efficiencies. The parameters defining a Right are comprised of name value pairs: the parameter name (what is being tracked) coupled with the associated value.

Code elements define the way in which a Right is processed by the system. In particular, the code element covers unique processing requirements of the specific type of Right. For example, certain aspects related to the processing of a transportation Right will obviously differ from a transformation Right. The processing is independent of any particular value input for the name value pair. The code should use these name value pairs in a fashion similar to variable declarations where the code processes regardless of the actual values.

Code elements are created in many ways. The simplest is to directly hard code the functioning of the Right. This approach benefits from simplicity and rapid processing speeds. However, hard code is inflexible and requires an experienced software engineer to develop. Typically, the software engineer does not have the necessary business domain knowledge and, thus, requires the translation of business knowledge by a domain expert. An alternative is to “code” the business logic using a natural language system, which allows the business user to input domain knowledge in the language of the business user. This generally results in slower processing speeds since the system is now responsible for the translation. The actual approach will depend on the system requirements and will probably be a synthesis of both approaches.

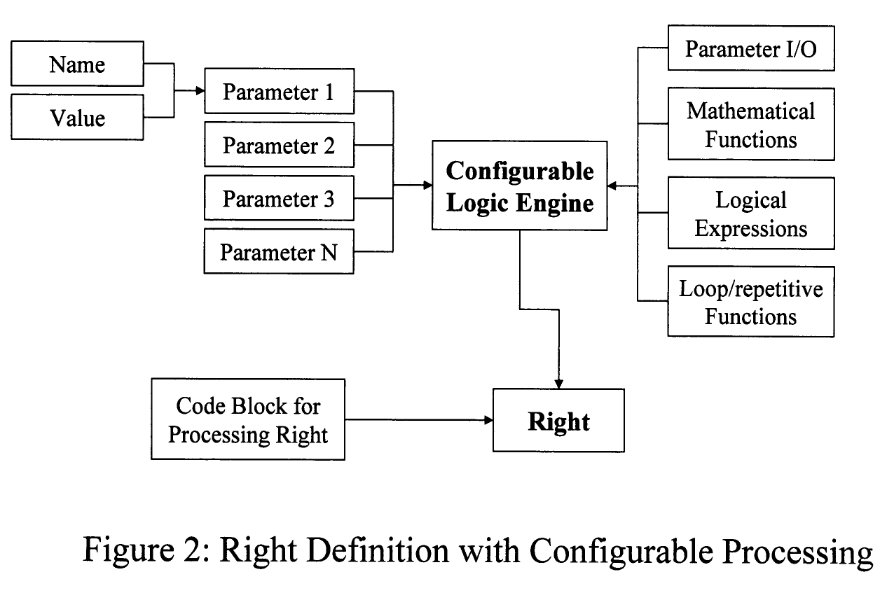

FIG. 2 shows a more advanced version of the Right definition process. The main difference between FIGS. 1 and 2 is the incorporation of a configurable logic engine. The configurable logic engine is able to enhance the basic functioning of the Right defined in the hard-coded code block. The logic engine pulls the values from the name value parameter pairs. The logic engine is then configured to perform a variety of processing functions, including basic mathematical calculations: addition, subtraction, multiplication and division. The system can also handle more advanced calculations: summations, minimum/maximum selection and averaging. Simple logical expressions are also included as basic processing functions. The logical expressions include Boolean queries and if—then selections. The logic engine can also process looping functions, which allows for the expression of iterative processes. Finally, the logic engine may allow for the creation and definition of input and output variables. This effect would be similar to the creation of parameters in an as-needed fashion. The combination of some of these capabilities in a logic engine will enhance the definition and ability to configure the Rights, without the need to hard-code Right behavior.

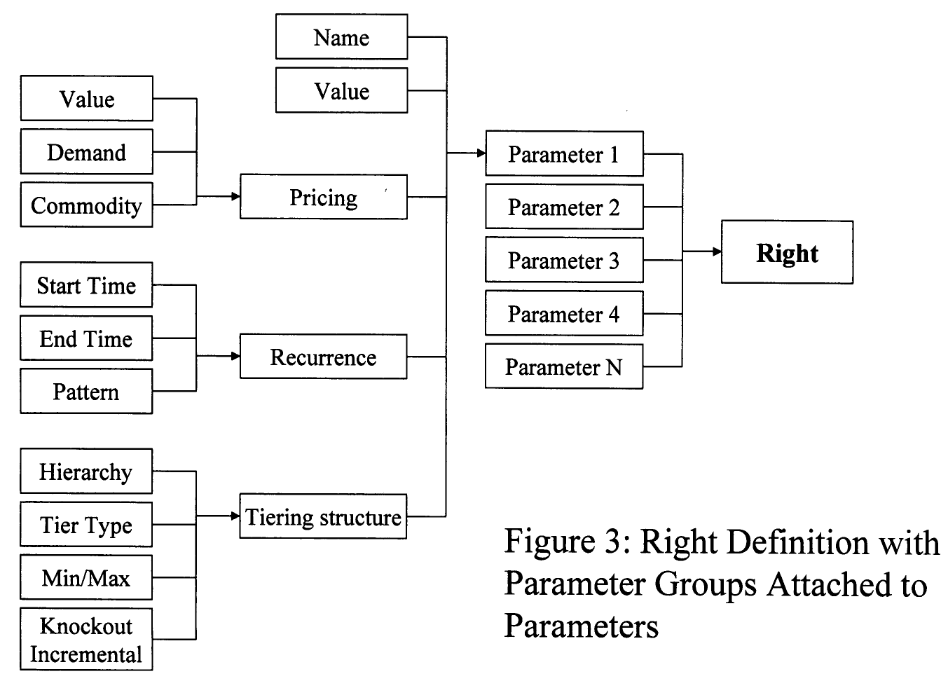

FIG. 3 shows—a Right with Objects (Parameter Groups) attached to individual parameters. In the system, Objects and Parameter Groups are used interchangeably. Parameter Groups are logical groupings of parameters where the parameters are organized by their specific function. Objects, while similar to Parameter Groups, also include an element of behavior to encompass the operations or functions that can be accomplished by the parameters. Objects and Parameter Groups are used to provide packaged functionality to the generic Rights. The concepts of Tiering, Recurrence and Pricing are examples of parameter groups that can be attached to individual parameters.

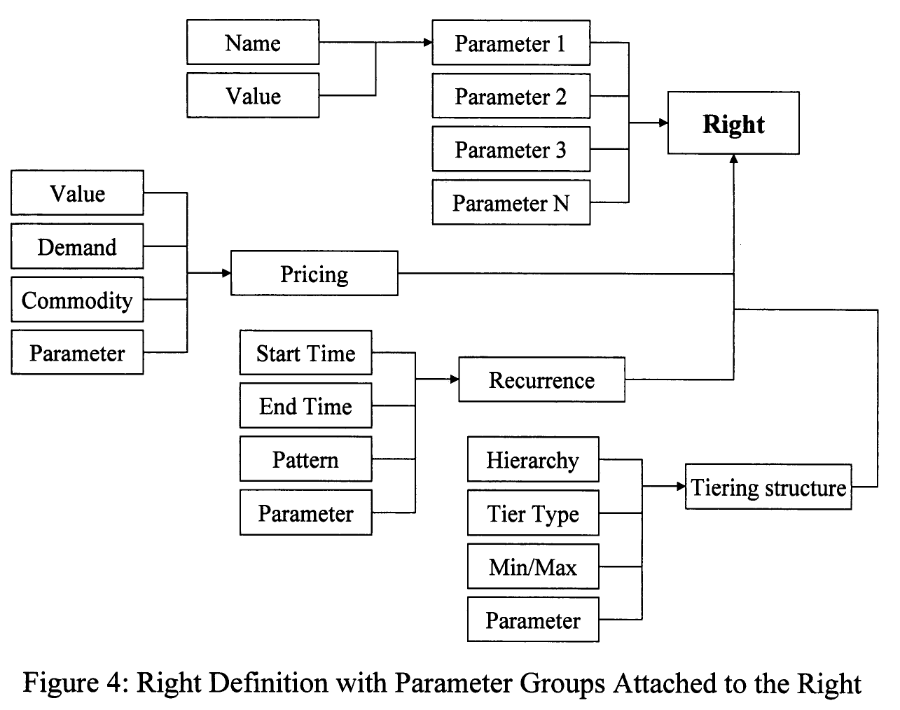

FIG. 4 shows a Right with an Object or Parameter group attached directly to the Right. In FIG. 4, the additional functionality provided by the object is tied to the Right in its entirety instead of only being attached to a single Right Parameter as in FIG. 3. The Object/Parameter group may include one or more parameters that link the functioning of the Object back to the Right parameter(s). Linking the Object to a single Parameter would have a similar effect to attaching the Object or Parameter group to the Right Parameter as in FIG. 3. The types of Objects and Parameter groups that may be attached to the Right are again the same as in FIG. 3 (tiering, recurrence, pricing).

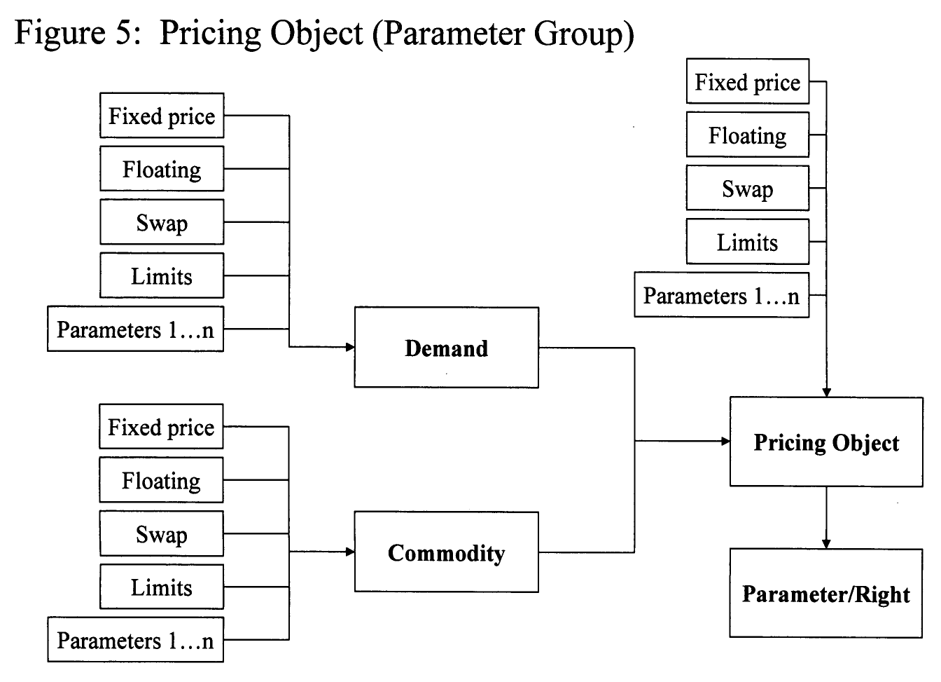

FIG. 5 is a detailed view of the pricing object. The pricing object has both demand and commodity components. This structure facilitates option-based pricing. In the event that either the demand or commodity is not priced, the parameters can be zeroed or the corresponding component eliminated. Five structures representing different pricing methods are shown feeding into both components. The simplest method is straight-fixed cost where an absolute value is assigned to the Demand and/or Commodity component. A slightly more complex version is a fixed-cost per unit. This pricing method requires both the cost per unit (fixed cost component) and a Parameter specifying the unit and quantity. This scheme demonstrates the benefits of providing access to the configurable logic engine within the pricing component. These benefits are even more apparent as the complexity of the pricing structures increases. Although a logic engine is not depicted in FIG. 5, the inventors fully anticipate the implementation of this feature. The floating-pricing method allows for pricing relative to a moving index, examples include: spot prices set by exchanges, such as the Chicago Mercantile Exchange. This pricing method requires input of the floating index and potentially an offset from the index (fixed price). A fourth pricing alternative is based on swaps. With swap-pricing one element of value is exchanged for another element of value. The value can be defined by any of the preceding pricing methods; thus, swap pricing must encompass the other pricing methodologies. The use of swap pricing allows the seller and/or buyer to couple a financial instrument to the good being sold. For example, transportation prices could be based upon the difference between two liquid markets. The last pricing method shown is limits. Limits are intended to place caps, both floor and ceiling limits,) either in terms of total dollar figure or cost per unit on the value of an exchange.

In addition to the Demand and Commodity component, a group of parameters similar to these elements are attached directly to the Right. This Parameter group allows for the combination of Demand and Commodity limits. It can also be used to price additional elements of a Right. For example, in the gas transport industry the basic transportation Right is charged a Demand, a Commodity and a fuel usage fee. The currency used to pay the fuel fee is not necessarily a dollar denominated figure. As in options trading, payment is frequently made in-kind, (i.e. the payment is made in the commodity traded). FIG. 5 is intended to show generic pricing structures and not limit alternative pricing strategies.

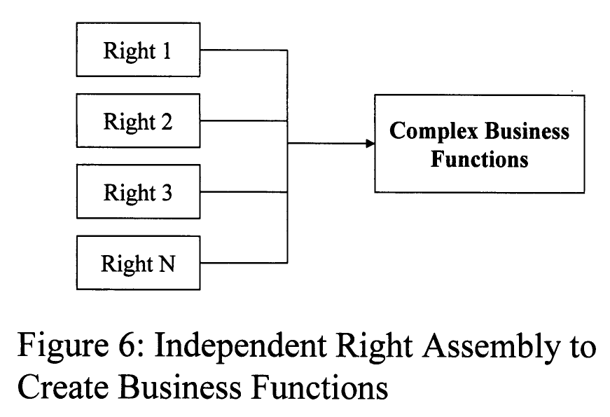

FIG. 6 shows the most elemental method of Right assembly yielding a complex Business function. The situation pictured by FIG. 6 assumes independent action by the Rights. Many Business functions are supported by this simple approach. The incorporation of the logic engine with the Rights (FIG. 2) maintains a high-level of flexibility.

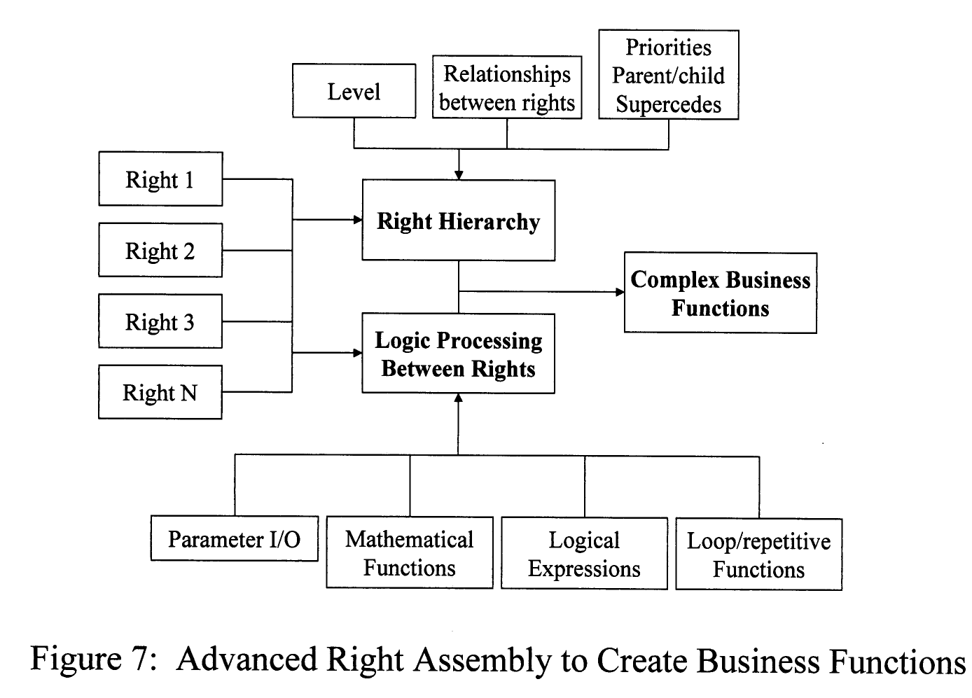

FIG. 7 depicts the elements of a fully featured Right assembly system. A hierarchy structure and access to a logic processing component enables full flexibility. The hierarchy component is similar to the tier structures within a Right. The main difference is the level of action required (entire Rights vs. Right parameters). The logic processing between Rights can potentially be maintained by the same logic engine, which creates dynamic logical processing within individual Rights. Just as with the Right hierarchy, the primary difference between the logic processing for Rights vs. Parameters is the level of action required.

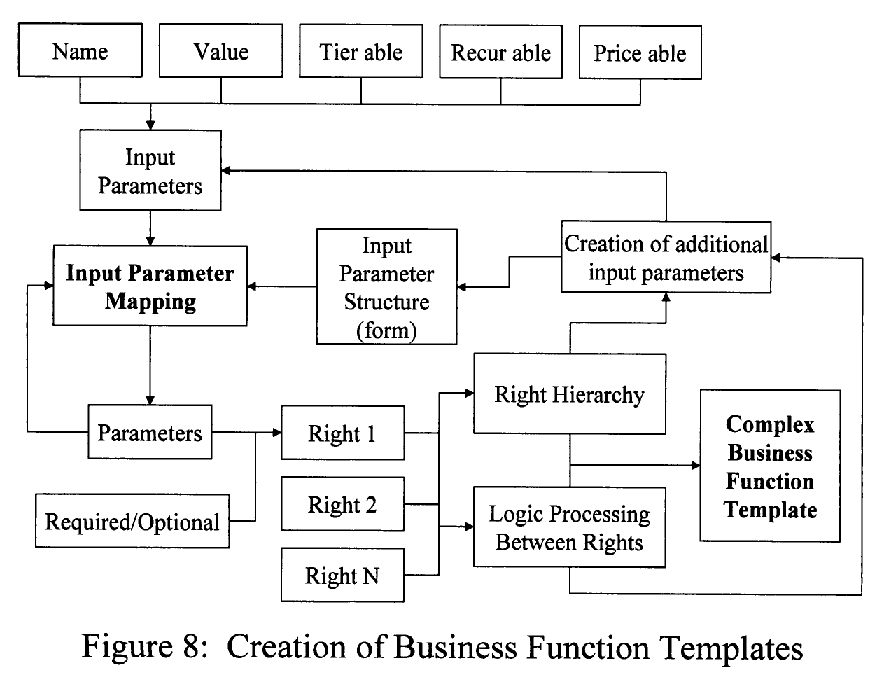

FIG. 8 depicts the role of input parameter mapping for the population of the Rights, which are defined in a service template. The magnitude of the work involved in: identifying each Right, defining the logic, establishing the hierarchy and populating all the parameters each time a complex business function (service) is initiated, leads to the creation of service templates to minimize the workload associated with the creation of any recurring or frequent business function. FIG. 8 shows the process of developing these service templates. This process, “templating”, is applicable to all services defined by the process depicted in FIG. 7. The “templating” process requires the author of each template to identify the necessary input parameters. These input parameters are the values that the template user(s) will be required to supply in order to create an instance of the desired business function. The input parameters feed into the Input Parameter Mapping module, which coordinates the population of all Right parameters included in the particular service template. There are several levels of mapping. The foundation level directly maps an input parameter to a Right parameter. The next level takes an input parameter and maps it to the Right parameter using a formulaic expression. The formulaic expression can use the input or Right parameters to create a single Right parameter. The most complex mapping scheme allows the dynamic creation of input parameters. These input parameters are created as the instance of the service is generated from the template. These potential input parameters may or may not be present for any one instance created by the template. A simple example of this situation is the creation of tiers. During instantiation of a Service, one to many tiers may be defined in which, each tier maintains a subset of parameters. These parameters also require mapping. If the number of tiers is dynamically set at the time of instantiating an instance of the template, the mapping function necessitates the creation of additional input parameters for each new tier. This creates the cyclical process of FIG. 8 where additional input parameters are created and passed back into the input parameter mapping module.

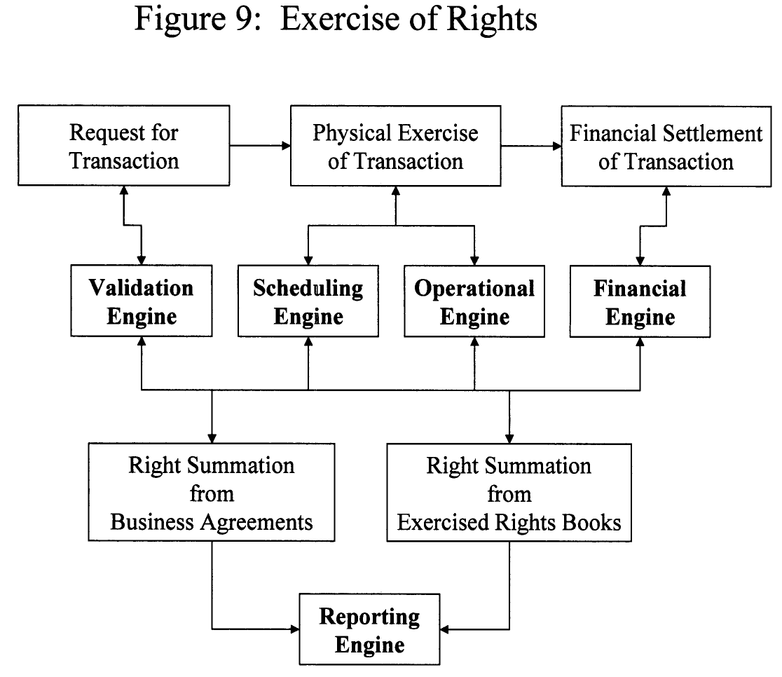

FIG. 9 shows a generic business process and the engines, which support the process. The generic business process follows the sequence of requesting a transaction, physical exercise of the transaction and financial settlement for receipt of the transaction. This scenario assumes the existence of an instantiated Service agreement. The transaction request is first processed by a validation engine, which determines whether the transaction requester has the Rights in a service to fulfill the requested transaction. The validation engine accesses the database of Rights available to the requester and the previous Rights exercised by the requester. Upon the successful validation of a transaction request, the business process moves to the physical exercise of the transaction. A scheduling engine and operational engine support this process. The scheduling engine queues the validated transaction request instead of other pending requests. The operational engine exercises and updates the Rights required by the transaction request. Upon completion of the physical exercise, the business process moves to financial settlement. Financial settlement includes the creation of an “Invoice”, where the user is charged for the Rights purchased and exercised. The potential exists for Rights to be created that are only exercised upon a settlement procedure. A credit limit trigger is an example of a Right, which is exercised only during settlement. A credit limit results in Rights being recalled or the request for an additional credit deposit. A reporting engine supports the business process. The reporting engine provides the means for internal or external business groups to access the granular Rights data. The view of the Rights is defined by the requirements of the user. The summation is determined by the assembly structure, contained within the Rights and services.

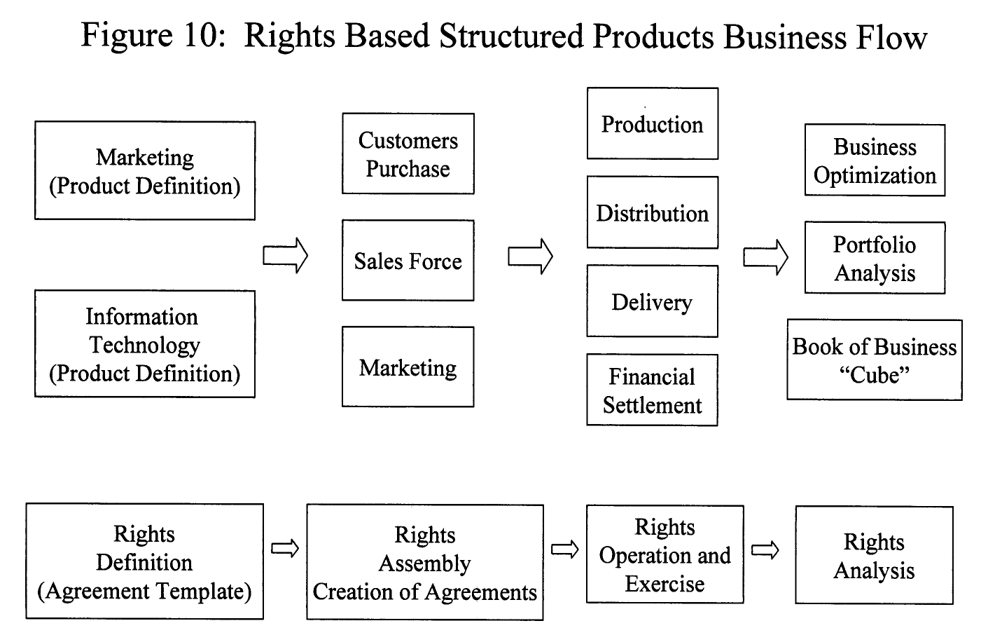

FIG. 10 shows some of the business functions supported by the structured products core arranged over the corresponding Rights-based process, which manage the functions. The Rights-based process includes: the Right definition, the Right assembly, the Right operation, and finally the Right analysis. This combination depicts a Right's life cycle. Each stage in the life cycle supports the corresponding business functions. The listed business functions are not intended to be comprehensive merely provide examples of possible business functions.

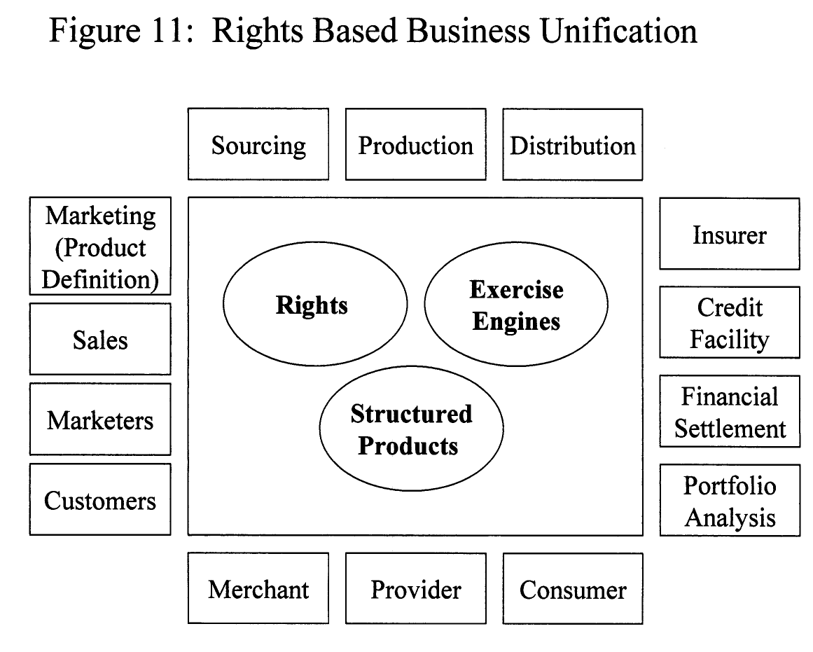

FIG. 11 is a pictorial view of the structured-products core, which supports multiple business areas and functions. The actual implementation of the business areas will ideally be accomplished with a component-based architecture. Preferably, the components will be selected from those already commercially available. Alternatively, custom-made components will be created to provide tailored user-functions. In either case, the structured products system, with its granular data storage, the Rights assembly process and various exercise engines, facilitates the implementation of component-based enterprise systems.

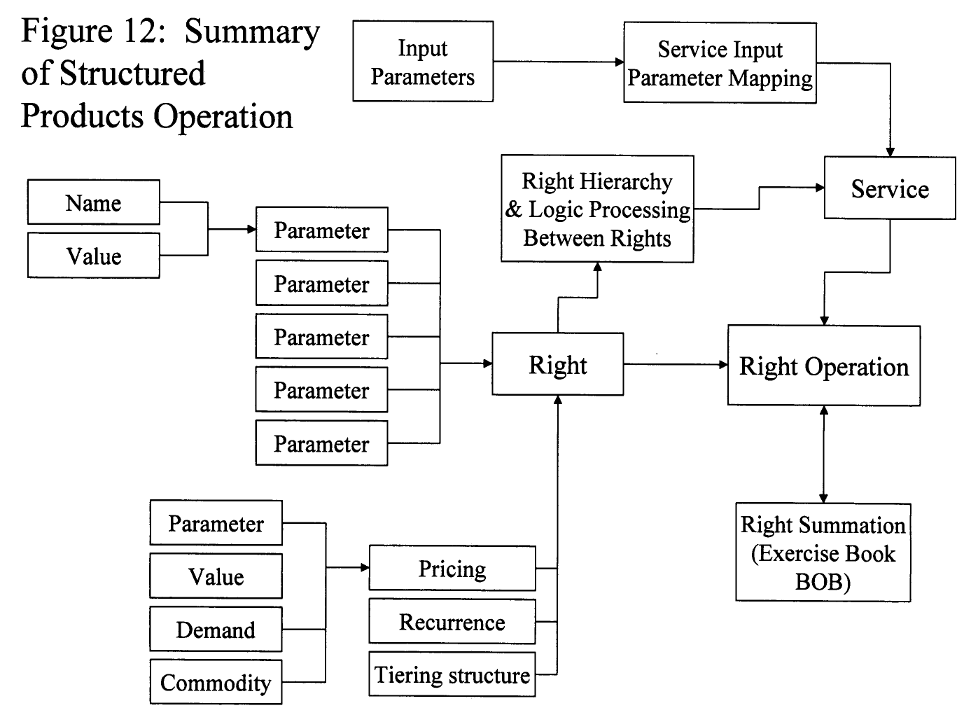

FIG. 12 shows the concept of a service within the framework of Rights, the Rights hierarchy, input mapping, and the Rights operation/Exercise engines. In the context of the Structured Products System, a service and a business process are used interchangeably. In FIG. 12, the junctions between Right/Service and input parameter/service are many-to-one relationships, (i.e. many Rights or input parameters have one service). The details of the other relationships can be found in the description of the other Figures.

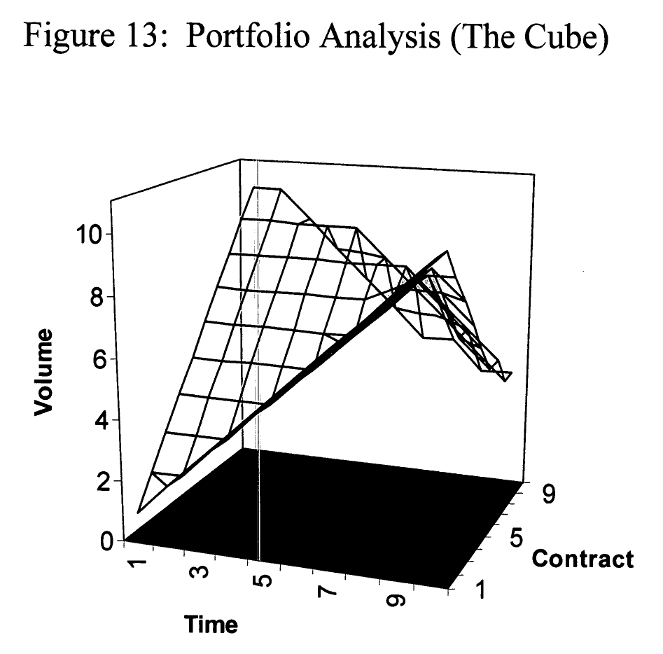

FIG. 13 presents the concept of the “Cube”, which is an analysis tool for the visualization of the multi-dimensional data. The cube allows for the user to view three-dimensions of the possible n-dimensions defined by the particular industry. The multi-dimensions arise from different methods of summing the fundamental data sets. While the cube is one method for the expression of data, it holds the possibility of maintaining all system data. Therefore, it may be used as the basis for the entire on-line analytical processing (OLAP).

Operation of Invention

The basis of the Rights Based System (RBS) is the process of decomposing services into core constituent Rights. These core constituent Rights are then recombined through the flexible Rights Based System such that any service can be managed. This general system overview is intended to show how the envisioned Rights Based System could operate. In this example there are nine primary elements, which cover the life cycle of the Right from Right definition through Right analysis as shown in FIG. 10.

Service Decomposition

The first and critical aspect of the structured products based management process is to break the business processes into their core components. The accurate and complete definition of the core components is essential for the subsequent reassembly process to work properly and to be sufficiently flexible to accommodate variations within business processes. Many of these basic Rights are actually applicable across industries. Examples of Rights and their functional description are given in Table 1.

TABLE 1

| Right | Functional Description |
|---|---|
| Travel Path (Defined & | Specifies the route that a product can |
| Undefined) | take. |
| Segmentation of Path | Allows the use of different elements |
| | (Rights) of the service in multiple |
| | transactions rather than linking all |
| | Rights to a single transaction. |
| Secondary Market | Can the initial purchaser resell the |
| | service? Defines how these |
| | transactions can be structured and any |
| | limitations. |
| Secondary Market Recall | Can the service being sold be recalled |
| | by the seller? |
| Revenue/Volume Commitments | The purchaser guarantees to use a |
| (Price) | certain amount of a service determined |
| | either with a volume or revenue. |
| Notification Period | Defines the time periods that the |
| | customer can schedule the delivery of |
| | a product or service. Defines the |
| | sellers guaranteed lag time between a |
| | request by a customer and the |
| | subsequent fulfillment of that request. |
| Volume | The quantity allowed under the terms |
| | of the transactions. |
| Scheduling Priority | This Right defines the priority for |
| | delivery of the service relative to the |
| | requests of other potential customers. |
| | Scheduling priority can also be |
| | implemented as a parameter on a |
| | specific Right. |
| Contract Extension | Can the term of the contract be |
| | extended and what are the |
| | implications to underlying Rights. |
| Contract Termination | This covers the implications of |
| | premature contract termination. |
| Banking | Facilitates the storage of a commodity. |
| Overall Rate Ceiling/Floor | Maximum and minimum pricing. |
| (Price) | |

It is evident that with a set of fundamental Rights it is possible to address a variety of cross industry processes. While it is possible to address many processes with the already described set of Rights the inventors fully anticipate the need to create additional Rights that serve functions unique to an industry. Once created these become part of the tools available for subsequent system upgrades ad base functionality on new system installations.

Right Properties

At a fundamental level the Rights are composed of two elements: parameters and an optional code block (FIG. 1). The parameters are further composed of a name value pair. The parameter maintains information on a certain aspect of the Right. Table 2 covers example parameters. The code block is specific for how the Right is processed within the system. Optionally the entire processing of the Right can be managed through the various exercise engines, which are discussed later.

TABLE 2

| Parameter Name | Parameter Description |
|---|---|
| Right Type | This information is utilized by the Rights |
| | Exercise Configurator & Schedule engines and |
| | determines the code that should act on the Right. |
| Right Status | Status covers the state of the Right in terms of |
| | active, inactive, exercised, scheduled etc. |
| Right Contract Term | This defines the Right start date, end date, |
| | creation date, and other overall contract term specifics. |
| Commodity | Specifies what (in a physical sense) the Right |
| | is covering. |
| Exercise Periodicity | This determines how often the Right can be |
| | exercised. (Second, Minute, Hourly, Daily, Weekly, |
| | Monthly, Yearly, Term . . . ). Alternatively this parameter |
| | may be part of the recurrence object. |
| Volume | The volume that can be utilized at each |
| | exercise. Also, there is a volume associated with the term |
| | of the option. |
| Time Between Exercises | The time that is required before the customer |
| | can exercise this Right again. |
| Right Term | The term of this Right. It should be noted that |
| | this is different from the term of the contract. The term of |
| | the option can be considered daily for hourly business. |
| Minimum/Maximum commitment | Specifies whether a Right must be exercised to |
| | a minimum or maximum condition. It covers an |
| | obligation of a customer. |
| Premium | The premium is a two-part figure. The first |
| | part is associated with the exercisable volume, and the |
| | second part is associated with the term volume for the |
| | Right. (Can be part of the pricing object) |
| Exercise Cost | Exercise cost is also a two-part figure. The |
| | first part is associated with the exercised volume and the |
| | second part is associated with the overall term exercised |
| | volume. . (Can be part of the pricing object) |
| Overall Cost | Defines the parameters based around an |
| | overall cost number for the non-exercise or exercise of |
| | this Right. (Can be part of the pricing object) |
| Number of Exercises Allowed | This determines how many times during the |
| | day there can be an exercise of this Right. |
| Guaranteed or Not | This is a special characteristic that we include |
| | to help in scheduling and forecasting. The issue is, does |
| | the customer have firm Rights or not. |
| Must Exercise | This characteristic requires that the Right must |
| | be exercised. This is used in special cases, when one |
| | Right exercise triggers a must exercise Right. |

The parameter values such as commodity of interest will tend to be highly industry specific. However, the fundamental processing of the parameters will transfer across industries. For example in the chemical processing industries the transformation Right may take unsaturated fats as input and produce saturated fats as an output. The from and to parameters would be unsaturated fats and saturated fats respectively. In the gas industry the transformation Right may take Liquefied Natural Gas (LNG) and convert this to pipeline grade gas. The from and to parameters now being LNG and pipeline gas. While the values of the parameters may be changing the processing remains the same. In a general sense product A goes to B (B=f(A)). Once processing for rate, time interval, multiple products or multiple starting materials is implemented, the actual transformation handled is mainly a matter of specifying the variables.

System flexibility is provided by the parameters and the potential to dynamically redefine and enhance parameter operation utilizing the configurable logic engine (FIG. 2). At a basic level the logic engine allows a parameter to be expressed as a function of another parameter(s). In a more complex application the logic engine serves as a source for additional parameters, which the system maintains and are available for subsequent processing. This flexibility allows customization of the fundamental Rights to address additional processes not initially envisioned.

While the Rights can be constructed with an extensive parameter list the grouping of parameters and associated functions into logical subunits allows for simplified configuration. FIGS. 2, 3 and 5 show examples of Pricing, Recurrence and tiering structure objects/parameter groups.

The tiering object allows a single Right to have multiple values for a single or group of parameters that are dependent upon the condition or value of a parent parameter. Accounting for minutes on a typical cellular phone plan can be expressed in a tiered structure. For example a plan may allow 100 on peak and 500 off peak minutes. Minutes used in excess of the allowed minutes results in an incremental charge. There are several accounting rules that apply to the minutes. Off and on peak are accumulated at specified times during the day. After all off peak minutes have been used additional off peak minutes are accounted for as on peak. After all on peak minutes have been used additional on peak minutes are accounted for as charged minutes. To express the business logic in the preceding example requires separate tiers for the on peak, off peak and charged minutes. The applicable tier is based on the time at which the minutes are used. Thus the time window at which the call is placed is the parent. In addition several logical rules must be applied to redirect the system to the correct tier on the occasion that the airtime in a tier exceeds the specified level of minutes. Traversal of the tiered constructs requires the tier to maintain both its structural relationships and the logic rules dictating the type of call being placed.

The concept of time is also maintained by the parameters. In the Rights Based System time is a relative concept. There is no set definition of time, nor is there any time periods which the process is built around. Everything is defined in terms of start time and end time. By defining time boundaries, industries that need second by second tracking can be accommodated along with industries that simply need hourly or daily tracking. Additionally, a combination of time granularities can be achieved within the same process. The recurrence/profile object or parameter group serves to neatly package more advanced timing concepts but still adheres to the original timing principle where no fixed clock cycle is set.

Recurrence covers the details of complex timing sequences. To deal with business processes that involve multiple transactions occurring over extended periods certain Rights are replicated over variable time durations at uniquely defined intervals. Recurrence is designed to easily express the periodicity of the fundamental Rights using a uniform process and set of parameters. The defined recurrence then facilitates the expansion of the Right with a recurrence pattern to multiple expressions of the Right each with the desired time parameters sufficiently detailed. The basic parameters in recurrence are the start time and end time. This start time and end time is further defined by a recurrence pattern. For example the Right to attend a college course associated with a scheduling application may have a recurrence object. The particular course may have a start time and end time of 10 and 11 respectively. The recurrence pattern may be M, W, and F and apply for the duration of the semester. The recurrent object and attendance Right thus express the student's Right to attend class.

The pricing object is the most complex object (FIG. 5). The pricing object allows a value to be associated with the individual Rights. The value of the pricing object is structured as a financial option with separate demand and commodity attributes. This approach increases system flexibility by separately accounting or charging for the demand—the ability to exercise a Right versus commodity—exercise of that Right. The distinction between demand and commodity can be illustrated with the example of a home purchase. During a typical home purchase the buyer provides earnest money with an offer to the seller. Once the seller accepts the offer the earnest money guarantees the buyer the Right to purchase the house (demand). The commodity is the subsequent payment for the house upon closing. Any Right defined in the system can potentially be priced. Maintaining pricing as an object increases system flexibility because the price object may potentially be attached anywhere in a Right including the parameters, parameters within tiers and directly at the Right level. Pricing at each level is potentially required. A simple case is commodity usage charged different rates. A hypothetical utility may charge $0.10/kWatt for 0 to 400 kWatt per day usage, $0.09/kWatt for >400 to 2000 kWatt per day usage, and $0.08/kWatt for >2000 kWatt per day usage. This scenario could be expressed in the Rights based system as a rate Right that has three tiers each with a separate commodity charge. An infinite number of pricing scenarios can be described but the fundamental point is that by structuring pricing as an option allows the flexibility to capture most pricing structures especially when combined with the minimum, maximum, knockout and swap parameters.

Additionally the pricing object allows for costing in terms of non-financial costs. The external interaction of companies is typically financial in nature but internal functions are often resource constrained vs. financially controlled. Tracking the non-financial costs is essential for any supply chain management function. It is also applicable to operations optimization. The options based pricing in conjunction with pricing based on resource utilization allows a company to fully address marginal costs, marginal revenues and decision making based on incremental modification versus management by the aggregate. Management in aggregate allows companies to maximize revenue but is does not allow for maximization of profit. Maximizing profit requires the separation of demand and commodity costs in addition the incremental impact of exercising a particular Right must also be calculated. Only then can a business be managed for maximal return.

Services:

Once the fundamental Rights of a business or business process have been defined, these Rights can be reassembled into services. Services are the unique combination of Rights that represent a product offering by a company. In one regard services are merely a placeholder for an aggregation of Rights. However, services are potentially more than a product offering. The Rights can be assembled to create other business functions. For example supply chain management can be expressed in a Rights based system. The performance of a particular supply chain function such as delivery of good G from location A to location B may require X, Y, and Z resources which when requested are expressed as Rights X, Y, and Z used to accomplish the movement of G.

Each time a product is sold, it could be assembled starting from the individual Rights. It is more expedient to preassemble these Rights into services. Unlike Rights which may be applicable across industries, services will be unique to an industry. FIGS. 6 and 7 show how Rights can be assembled to create the complex business functions. Obviously FIG. 6 represents the simplest method for Right assembly. In this situation the Rights are fully independent. The simple e-commerce transactions that involve a selection, payment, delivery and termination can be managed with these types of Rights based services. The more complex services or eCommerce transactions requiring multiple events with interlaced dependencies require the more complex modeling structures that can be created using the process of FIG. 7. FIG. 7 shows services (complex business functions) that are an organized assembly of Rights. The service maintains a hierarchy of Rights and logic functions to assist in the transversal of the Right hierarchy.

Once the service has been assembled it is immediately obvious that instantiation of an instance of a service will require the population of a significant number of Right parameters. In order to minimize the input required by the user especially for services that are frequently used the concept of a service template was conceived. Creation of a service template requires the identification of the “input” parameters. The input parameters are the essential parameters that define a service. These inputs are subsequently mapped to all the parameters of all the Rights on the service. The mapping function can use constants, simple math and logic functions to convert these inputs into populated Rights. The end result is the service template. Now the user can simply select a template, provide the input parameters and the result is a populated service. Within the concept of the service template is the utility to have optional Rights. Optional Rights are expressed as part of the mapping process and increase the flexibility of the templates. For example: If a service was generated whose only difference from an existing service was the existence or lack of a specific Right, this scenario could be managed with a single template and an optional Right.

Structured Products Usage

Contracting

Use of the structured products starts with the concept of contracting. In the structured products world contracting entails not just the contractual relationship between a buyer and seller of a good. Contracting also covers the complex relationship involved in service industries where the product supplied has a complex lifecycle or the fulfillment of a contract takes multiple actions by both the seller and purchaser. Additionally the contracts may cover internal company processes. Prime examples are supply chain and manufacturing production management.

Creation of a contract can take the form of instantiating a service template by supplying the input parameters, populating all the parameters under a service or assembling the Rights independently and then populating the parameters. Each contracting process requires an increasing level of knowledge about the business and Rights based operation.

During contracting the recurrence object may have been invoked on one or more Rights. Once the recurrence parameters are fully populated the Rights can be expanded according to the timing sequence defined in the recurrence. For example in an injection molding shop a contract was created for the production of 100 k injection molded pieces per day over the course of 6 months. The shop works Monday to Friday from 8 to 5. The Right for creation of the 100 k pieces per day would be duplicated to every weekday for the duration of the 6 month contract. For contracting we capture all the Right information within the recurrence, and it is not necessary to do the expansion for the expression of the contract. However, this level of granularity is required for utilization of the Rights. While not absolutely necessary we can keep the contract at the most granular level required by the business thus minimizing some of the system processing requirements.

After the contract has been fully expressed it is then possible to perform business using the contract. The contract and its Rights define what the customer can do or request and the required response of the company. Obviously the business being performed is completely dependent upon the industry; however, the basic Rights and the assembly process should traverse the industries. It is anticipated that several generic Right operation engines will be required. The first engine is a validation engine. Obviously when a request is received by the system, the request must be confirmed against available Rights to ensure that the request is valid. The incoming request is broken down into the same granularity that the contracted Rights are stored at. The request is then stored to the database with a status parameter indicating where the request is in the overall business process.

Upon validation of the Right the request will be passed to a scheduling engine. The scheduling engine prioritizes the incoming requests and creates a que for subsequent action. The prioritization algorithm can take many different forms. The primary factor is what variable(s) determine priority. Obviously the service provider will want to prioritize for maximal return while the purchaser will have certain prioritization benefits due to the type of service purchased. This engine potentially requires the storage and processing of a significant number of business rules. One alternative to a strictly business rules approach is to assign a priority to each contracted Right. To prioritize a request a summation of the priorities of the Rights to be exercised is executed. This sum determines the priority for action. The obvious benefit is the simplicity of action versus traversing actual business rules. In addition it is easier to change the priority of a Right (simply a Right parameter) as opposed to recoding fixed business rules.

Once the requests have been queued according to Right priority the service provider can optimize their operations to handle the requests. Since each request is a compilation of the atomistic operations, as expressed in the Rights, the service provider is able to truly see the impact for each operation. This level of detail allows for a more complete systems operation. Realistically, the quantity of data generated will exceed an operator's ability to efficiently process all of it. This necessitates a method to provide data summation or a method to automate the optimization process.

After the requests have been appropriately scheduled, the actions specified by the Rights are allowed to proceed. It should be noted that the Rights Based System would not necessarily carry out the activities. In most cases the actions will entail some physical process, which the system will only monitor. Once the actions have been completed the results of the actions are passed back into the RBS where they go to the settlement engine.

The settlement engine determines the final charge monetary or other for the actions. The engine will have to perform the following tasks. First the demand charge is calculated. The demand charge can actually be calculated at the time of contracting but the calculation is none he less processed by the settlement engine. Once actions are completed the system imports the results of the actions. The actions must first be associated to a particular contract. In most industries the allocation of an action to a contract is strait forward. However, some industries operate with shared capital resources and commodity products. Here the allocation can be more complex and the business rules must be coded into the settlement engine. Once the actions are assigned to a contract the commodity charges can be calculated. The pricing object allows for a very complex pricing scheme. While for basic cases only a demand and commodity charge is calculated, the more sophisticated pricing will require checking for minimums, maximums and inter Right dependencies. Additionally settlement will have to manage any unique pricing event such as penalties or overruns for non-compliance with contracted terms. Ideally the structured products system would prevent the customer from exercising Rights which they do not have. In reality many industries do not have the ability to fully control their operations, and they are forced to respond to customer actions after the fact. The result is that there is the potential requirement for some manual adjustment of the settlement process.

Portfolio Analysis

Portfolio analysis is one of the strengths of the Rights Based System. Since all the data is maintained at an atomistic level, the status of the entire business can be viewed according to the needs of the individual user. The “cube” as shown in FIG. 13 is one means for visualizing the data source. The actual database can store the results in n-dimensions but we can only visualize any three dimensions simultaneously, thus the cube. Table 3 provides an indication of possible dimensions for the cube.

TABLE 3

| Dimensions | Description |
|---|---|
| Asset | These are the major physical |
| | resources owned by the company. They |
| | may or may not be totally independent. |
| State | Forecast, Requested, Scheduled, |
| | Confirmed and any other state a Right |
| | may be assigned as it goes through the |
| | business work flow. |
| Scenario | Forecast scenarios will be the |
| | primary use of this dimension. It allows |
| | a look at the business assuming different |
| | input conditions. |
| Segment | Subset of the Asset dimension. |
| | Segments are dependent upon the |
| | adjacent segments. |
| Contract(s) | The individual business |
| | agreements made between the service |
| | provider and the customer. |
| Deal | The RBS term for umbrella |
| | contracts which combine multiple |
| | contracts. |
| Time | Time includes the present time |
| | providing a business “snap shot”, past |
| | performance and future forecasts. |
| Right | Any of the Rights from table 1 |
| Parameter | This could include any of the |
| | specific Right parameters such as Right |
| | type, volume, rate, tier and quantity. |

Once plotted the cube allows dynamic resizing of the X, Y, and Z axis scales such that the resolution of the data can be adjusted to the required granularity. For dimensions that are continuous such as electricity transported, it is a simple process to take a derivative of one dimension with respect to time or other parameter. This allows the system operators to identify swing events and transients which are the critical variables to manage in many industries. It also allows for forecasts based on business momentum. The portfolio analysis provided by the structured products system is far more flexible than what can be achieved with presently available online analytical processing tools (OLAP). The reason is that today's OLAP tools are placed on top of presently existing systems and are designed to integrate many different data sources and allow for their combined analysis. The Rights Based System starts with the database defined at an atomistic level of granularity. The primary business functions are managed through this database. Each stage of the business is represented as a status in the original database or a separate database still maintaining the low level granularity. The benefit for analysis is that all the data is readily available. The integration achieved by an OLAP often requires summation processes that obscure essential business details.

1. A process where business functions and or operations such as but not limited to contracts, transactions, services, logistics operations and or settlement are decomposed into Rights which are further composed of a collection of parameters and an optional code block which directs the system how to process the Right.

2. A process of claim 1 where the sequence of business functions and or operations from forecasting to contracting to operations to invoicing is represented in terms of Rights.

3. A process of claim 1 where Rights can represent the granting of specific Rights to suppliers and or customers and the receipt of specific Rights from suppliers and or customers to express complex contracts and or services and or recurring business agreements.

4. A process of claim 1 where the Rights define and or model business agreements in terms of embedded options that exist for suppliers and or customers and or sellers.

5. A process of claim 1 where the elemental components can have attached functions for recurrence and or pricing and or tiering and or scheduling.

6. A process of claim 1 where Rights can be reassembled to model complex services.

7. The expression of the process in claim 1 in a digital fashion which allows large numbers of Rights to be managed and processed.

8. A software system based on Rights where the Rights are specified by a list of parameters and values.

9. The software system of claim 8 which includes a function for the definition of Rights.

10. The software system of claim 8 where Rights include an element of code, which specifies how the Right is processed by the system.

11. The software system of claim 8 where the Rights are represented as objects, with parameters and behaviors, which allow the Right to function independently.

12. The software system of claim 8 where the Rights are defined with sufficient granularity to eliminate the summation of business details within an individual Right.

13. The software system of claim 8 where the Rights are expressed as options with a demand and a commodity aspect which allows for differentiation of the owning of the Right and the exercise of the Right respectively.

14. The software system of claim 8 where a Right has an associated status such as projected, available, purchased or exercised.

15. The software system of claim 8 that has the ability to dynamically modify Right operation by addition of input and/or output parameters, controlled by a logic engine.

16. The software system of claim 8 where Rights have parameters that define pricing.

17. The software system of claim 8 where Rights can have one or more non-tiered, tiered, nested tier and tier dependent parameters in any combination.

18. The software system of claim 8 where Rights can have tier-able parameters that allow a Right to have one or more tiers.

19. The software system of claim 8 where Rights can have priority parameters which allow the order for operation or exercise of Rights to be specified.

20. The software system of claim 8 where Rights can have state based parameters the values of which can be modified by the exercise or use of the Right and or by a recurrence pattern and or by a formulation based on parameter values.

21. The software system of claim 8 where the generic business functions represented by Rights and the workflows and or business processes interacting with Rights encompass the entire business value chain and or life cycle in the system.

22. The software system of claim 8 which has a Right specifically for scheduling (notification).

23. The software system of claim 8 which has a Right specifically for transformation (production).

24. The software system of claim 8 which has a Right specifically for transportation (distribution).

25. The software system of claim 8 which has a Right specifically for storage (banking).

26. The software system of claim 8 which has a Right specifically for valuation (pricing).

27. A software system incorporating Rights where the Rights are specified by a list of parameters and values where the Rights represent generic business functions and can be independently assembled to configure services.

28. The software system of claim 27 where the generic business functions represented by Rights and workflows or business processes interacting with Rights encompass the entire business value chain or life cycle in the system.

29. The software system of claim 27 where the assembly of Rights is accomplished via a hierarchical structure.

30. The software system of claim 27 where the assembly of Rights into a hierarchy includes the prioritization of the Rights.

31. The software system of claim 27 where a particular business function can be configured to execute a subset of Rights.

32. A software system incorporating Rights in which a Right can have associated one or more ancillary objects or parameter groups that enables the system to provide a pricing or valuation function.

33. A software system of claim 32 where the pricing is modeled after financial options, where the existence of the Right is priced separately from the exercise of the Right.

34. A software system of claim 32 where the exercise of the Right and/or the existence of the Right is charged based on the value(s) of parameters of the Right at either definition or exercise.

35. A software system of claim 32 where the exercise of individual Rights and the associated charges can happen at different times through the value chain and or business life cycle of the transaction and or contract and or service.

36. A software system of claim 32 where the pricing can be a formulaic expression or a function of Right parameters.

37. A software system of claim 32 where the pricing can be constrained by minimum or maximum values.

38. A software system of claim 32 where the pricing is modeled after a financial swap.

39. A software system of claim 32 where the pricing object or parameter group can have incremental or knockout tiers.

40. A software system incorporating Rights in which each Right can have associated one or more ancillary objects or parameter groups that enables the system to provide a tiering function within the Rights and or a hierarchy of Rights.

41. A system of claim 40 in which Rights can have tier-able parameters, structured such that a Right can have multiple tiers and or nested tiers.

42. A system of claim 40 in which the tiers can be modeled as incremental or knockout.

43. A system of claim 40 in which Rights can be assembled at multiple levels of hierarchy.

44. A system of claim 40 where Rights are assembled in a hierarchy with priority in the hierarchy.

45. A system of claim 40 where the objects or parameter groups can inherit the hierarchy and/or tier structures of the Right.

46. A software system incorporating Rights in which each Right can have associated one or more ancillary objects or parameter groups that enables the system to provide a prioritization or scheduling function.

47. A system of claim 46 in which the associated scheduling object is assigned a base value and a value upon exercise.

48. A system of claim 46 where the incremental scheduling or priority value is based upon one or more parameter values.

49. A system of claim 46 where the prioritization or scheduling object inherits the hierarchy and tiers of the Right.

50. A system of claim 46 where the prioritization or scheduling value is based upon the previous exercise of the Right and or the exercise of one or more other Rights.

51. A software system incorporating Rights in which each Right can have associated one or more ancillary objects or parameter groups that enables the system to provide a time interval and optionally a recurrence pattern for the Right.

52. A system of claim 51 where the system handles a series of transactions involving multiple events over different times with different parameters.

53. A system of claim 51 where the system handles a series of transactions where the Right contains one or more state based parameters that are modified by the exercise or use of the Right or by a recurrence pattern or by a formulaic expression of previous or existing parameter values.

54. A software system that provides for the creation of configurable services through the combination of one or more Rights.

55. A software system of claim 54 in which a configuration language for Rights allows for user configuration.

56. A software system of claim 54 that utilizes the exposed parameters of Rights along with hierarchies and/or tiers to enable the configuration of complex services.

57. A software system of claim 54 that utilizes the exposed parameters of Rights along with a logic engine to enable the configuration of complex services.

58. A software system of claim 54 where structure can be created through the configuration of logic between Rights.

59. A software system of claim 54 where specific Rights can be configured to be utilized and or exercised during specific business functions and or processes and or transactions.

60. A software system of claim 54 where structure can be created through the use of a number map scheme that effectuates an algorithm.

61. A software system of claim 54 where a natural language macro language is embedded within the systematic process enabling business users to define and or extend the behavior of Rights and or Services and or Contracts or an aggregation or configuration of Rights and or Services and or Contracts.

62. A software system of claim 54 where mapping schemes are used to populate the Rights from a set of input parameters.

63. A software system of claim 54 where mapping schemes are used to populate the Rights from a set of input parameters where the input or modification of the parameter value can be constrained based upon the security level of a particular user of the system.

64. A software system that processes Rights to accomplish business functions or services which specifically include business agreements and or the core business processes used to support the business agreements.

65. A system of claim 64 that is configurable to define and manage the value chain process.

66. A system of claim 64 where the Rights are contained in a service.

67. A system of claim 64 that allows the expression of the business functions or services in terms of Rights allowing for the tracking, monitoring, and the optimization of underlying physical assets.

68. A system of claim 64 that allows for the summation of one or more parameters.

69. A system of claim 64 that handles a series of transactions involving multiple events over different times with different parameters.

70. A system of claim 64 where the Rights contain all the necessary information to support the processing and or use of the Right.

71. A system of claim 64 that integrates a portfolio management system that allows users to view an aggregate position of the Rights sold and or underlying parameters.

72. A system of claim 64 that allows the tracking and or the monitoring and or the optimization of one or more physical assets.

73. A system of claim 64 that limits the use of Rights according to different roles including possibly roles of customers and or consumer and or merchant and or service provider.

74. A system of claim 64 that allows for the disassembly of services into atomistic Rights or groups of Rights and the subsequent sale or resale of a fraction of the original service.

75. A system of claim 64 that uses a mapping process to take individual billing or pricing components and map them into the individual Rights using a formulaic method.

76. A system of claim 64 where specific Rights can be configured to be utilized or exercised during specific business functions or processes or transactions.

77. A software system that allows for the definition and the use of Rights.

78. A Rights based system that performs portfolio management functions by calculating an aggregate position of one or more Rights or options.

79. A system of claim 78 that integrates a marginal cost optimization engine to provide actual marginal pricing information based upon anticipated Right utilization.

80. The use of a system of claim 78 to track and manage risk exposure.

81. A system of claim 78 that includes a forward curve with the portfolio management system to provide a potential risk exposure.

82. A system of claim 78 that includes a pricing engine that calculates the current market price for services based upon calculated market prices for the individual Rights within a service.

83. A Rights based system that specifically manages a series of transactions involving multiple events occurring over a time period.

84. A system of claim 83 where individual transactions can exercise a subset of Rights based upon the transaction and or business function executed.

85. A system of claim 83 where certain parameters of the Rights are state based and can be modified by the execution of the Right and or by a recurrence pattern and or by a formulaic expression of current or previous Right parameters.

86. A computer system that processes time dependent data without the necessity of defining a time interval on which the system operates.

87. A system of claim 86 where time is handled as a Right parameter and the system is easily adapted to any time interval.

88. A system of claim 86 where time is handled as a start time and an end time which in combination creates a duration as opposed to maintaining a specific time interval, thus, allowing the system to process events of any time interval.

89. A system that uses mapping schemes to facilitate the population of Rights from a set of input parameters.

90. The use of a mapping scheme of claim 89 to facilitate the population of Rights which create a template that can be reused.

91. The use of a mapping scheme of claim 89 to facilitate the population of Rights to create a template that can have user inputs and or defined constants and or inputs based on formulaic schemes.

92. The use of a mapping scheme of claim 89 that takes individual billing component parameters and maps them into the individual Rights on a formulaic method.
